(19) United States
(12) Patent Application Publication
(10) Pub. No.: US 2014/0351735 A1
(43) Pub. Date: Nov. 27, 2014

(54) VIEWING DRIVER EVENT DATA

(71) Applicant: Cartasite, Inc., Denver, CO (US)

(72) Inventor: David L. Armitage, Golden, CO (US)

(73) Assignee: Cartasite, Inc., Denver, CO (US)

(21) Appl. No.: 14/281,517

(22) Filed: May 19, 2014

Related U.S. Application Data
(60) Provisional application No. 61/825,841, filed on May 21, 2013.

(51) Int. Cl. G06F 3/0484

(52) U.S. Cl. CPC G06F 3/04842
USPC 715/771

(57) ABSTRACT

Methods, systems, interface and software are provided for customizing parameters and/or information for configuration, identification, and communication of streaming information notifications for individual or groups of drivers, devices, and events for a monitoring program.

### CROSS REFERENCE TO RELATED APPLICATIONS

This application claims priority to, and benefit from, provisional patent application Ser. No. 61/825,841, entitled “VIEWING DRIVER EVENT DATA”, filed May 21, 2013, which is incorporated by reference for all purposes.

### BACKGROUND

There may be many companies which have fleets of vehicles used by their employees. The liability for all of these employees and vehicles may cost a substantial amount of money. The companies may want to limit the cost and liability of these employees and vehicles.

In particular, the company may want to institute a monitoring program to identify increased risk based on driving behaviors. Furthermore, supervisors may want to configure and view information from the vehicles.

### OVERVIEW

Methods, systems, and software for customized viewing of asset management and information notifications are provided herein. The method includes presenting parameters(s) generally related to driving events of a driver or driver group to a user at least in part via an interface of a computing device, receiving setup indications for the parameter(s) via the user interface, implementing the indicated changes to the parameter(s) by the computing device, and providing streaming information generally related to the driving events, based at least I part on the parameter(s).

With this system and method a user may select metrics for various parameters receiving notifications related to remote assets. The user may set thresholds for notification creation and presentation. When information is received of a threshold being crossed, a notification may be sent.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several implementations are described in connection with these drawings, the disclosure is not limited to the implementations disclosed herein. On the contrary, the intent is to cover all alternatives, modifications, and equivalents.

FIG. 1 illustrates computing/communication device and interface in an implementation.

FIG. 2 illustrates an operational flow diagram of an implementation.

FIG. 3 illustrates a graphical user interface according to an example.

FIG. 4 illustrates a graphical user interface according to an example.

### DETAILED DESCRIPTION

Implementations described herein include a driver monitoring program. In particular, provided is a method, system, and interface for customizing parameters for configuration, identification, and communication of streaming information notifications for assets, an individual or groups of drivers for a driver in the monitoring program.

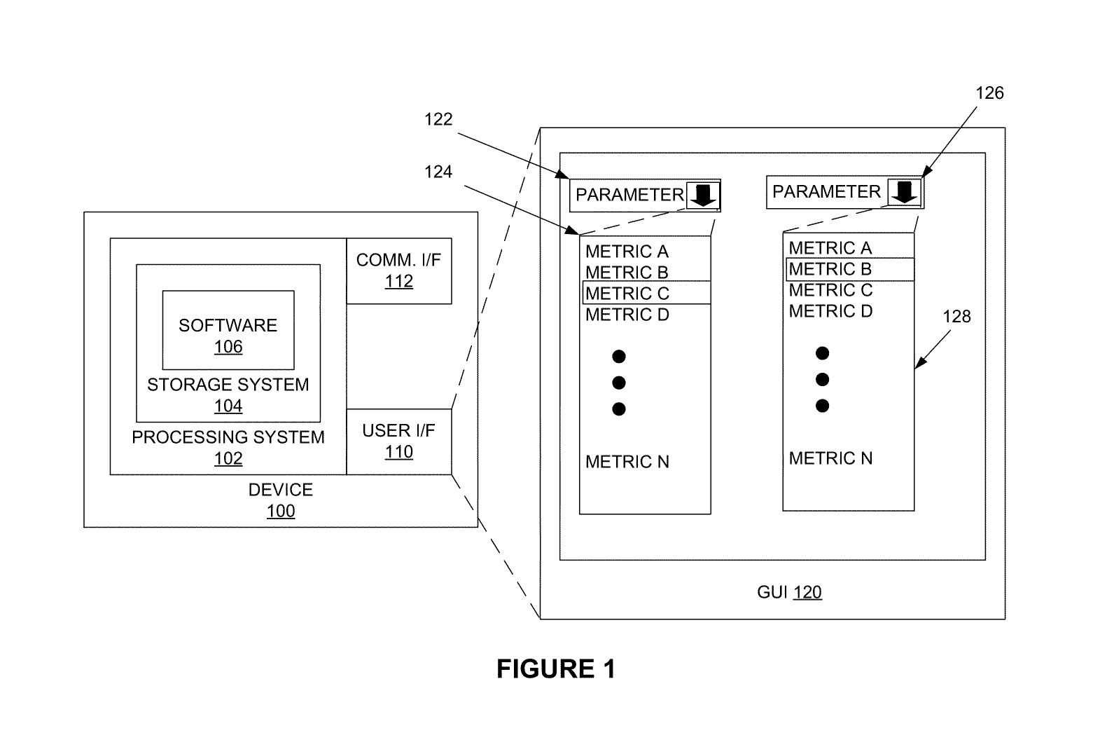

FIG. 1 illustrates communication/computing device 100. Communication/computing device 100 includes processing system 102, storage system 104, software 106, user interface 110, and communication interface 112.

FIG. 1 illustrates graphical user interface (GUI) 120 displaying an interface for presenting parameter(s). GUI 120 can include a presentation of selections 122 of customizable metrics 124 of suggested and/or approved customizable parameter(s)126 for driving information to select from to be included in a driver's information for creating, identifying, communication, and/or for notification of a the driver, group, supervisor and/or risk prevention person.

When a parameter is selected in 122, different suggested metrics 124 may be presented such that the user can select a metric for the parameter. Other parameters 126 and metrics 128 may also be changed or inputted as desired. An approximate amount of data, based at least in part on the selection of the parameter/metric, may also be presented to indicate to the user how much data the setting of the parameter/metric will cause to be created, communicated, and/or stored. This may be an important indication because data may be somewhat expensive to create, communicate, and/or store.

In this example the suggested metrics are displayed in a drop-down box. However, many other methods and scheme of presentation may be used. The user may set thresholds for the parameters. When information of a threshold crossing is determined from information received from devices or sensors, a notification may be created and sent.

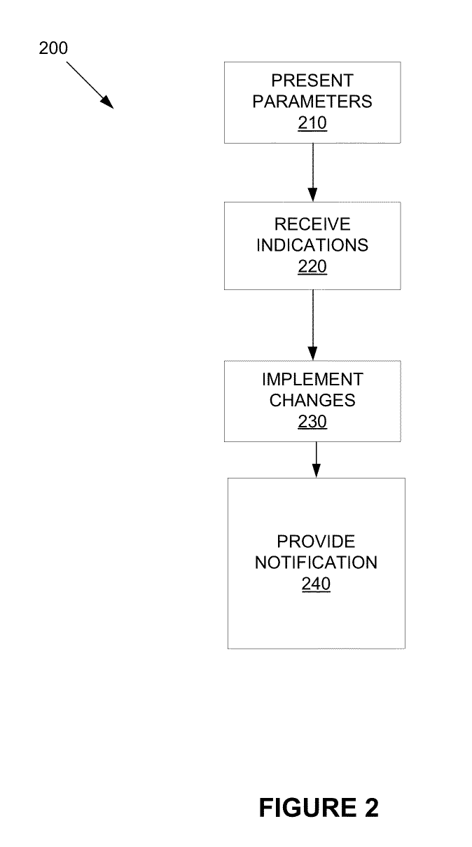

FIG. 2 illustrates an operational flow diagram 200. The steps of the operation are indicated below parenthetically. Computing device 100 is configured to present metrics and parameters (210). Presentation of parameters may include potential metrics which may be selected from. In this example, the metrics and parameter(s) may be presented via GUI 120 of a computing device 100. Other methods and systems may be used to present indicators without straying from the scope of this disclosure.

Changes/indications may then be received (220). The changes may include selection of a metrics corresponding to a parameter, or inputting of another parameter and/or metrics. An indication of the amount of data caused by the change in threshold may be presented to the user. The user may want to change selections based on the indicated amount of data.

The changes may then be implemented (230). The changes may include setting of thresholds for the various parameters and other information. If it is determined a threshold or other condition has occurred, streaming information or notification related asset and condition (250) may then be indicated via a computing device to a user. The streaming data may be based at least in part on the parameters and metrics indicated.

Examples of metrics/parameter(s) relating to driving events and event types can include vehicle speed, acceleration, braking, location, engine emissions, vehicle location, tire pressure, if the seat belt is being used, and others. Examples of monitoring devices could include global positioning systems, accelerometers, temperature gauges, as well as many others.

Communication device 100 may be a cellular telephone capable of initiating a telephone call, a text message, an email, a tweet, and the like. Communication device 100 could be a server, a personal computer, a smartphone, a cell phone, a telephone without a GUI, and the like.

In an implementation, communication device 100 may be a personal computer and may therefore contain GUI 120 capable of displaying indications, and receiving selections.

Referring back to FIG. 1, communication device 100 is represented in an implementation. Communication device 100 includes processing system 102, storage system 104, software 106, user interface 110, and communication interface 112. Processing system 102 is linked to user interface 110 and communication interface 112. Software 106 is stored on storage system 104. In operation, processing system 102 executes software 106 to operate as disclosed herein for a communication device.

Communication interface 112 comprises a network card, network interface, port, or interface circuitry that allows communication device 100 to receive data related to vehicle motion, position, operator driving history, vehicle destination, and the like. Communication interface 112 may also include a memory device, software, processing circuitry, or some other communication device. Communication interface 112 may use various well known protocols.

User interface 110 comprises components that interact with a user to receive user inputs and to present media and/or information. User interface 120, 300 and 400 may include a speaker, microphone, buttons, lights, display screen, mouse keyboard, or some other user input/output apparatus—including combinations thereof. For instance, FIG. 1 shows an example of user interface 100 displaying metrics and parameter(s) as can be seen on a GUI 120. User interface 120 may be omitted in some implementations.

Processing system 102 includes storage system 104. Processing system 102 retrieves and executes software 106 from storage system 104. In some examples, processing system 102 comprises specialized circuitry, and software 106 or storage system 104 could be included in the specialized circuitry to operate processing system 102 as described herein.

Storage system 104 could include a computer-readable medium such as a disk, tape, integrated circuit, server, or some other memory device, and also may be distributed among multiple memory devices. Software 106 may include an operating system, logs, utilities, drivers, networking software, and other software typically loaded onto a computer system. Software 106 could contain an application program, firmware, or some other form of computer-readable processing instructions. When executed by processing system 102, software 106 directs processing system 102 to operate as described herein, such as presenting and receiving selections for a metrics and parameter(s) for streaming information of a monitoring program.

Some or all of the systems and portions of device 100 may be distributed across multiple devices, computing system, software modules, storage systems, locations, areas, portions, etc.

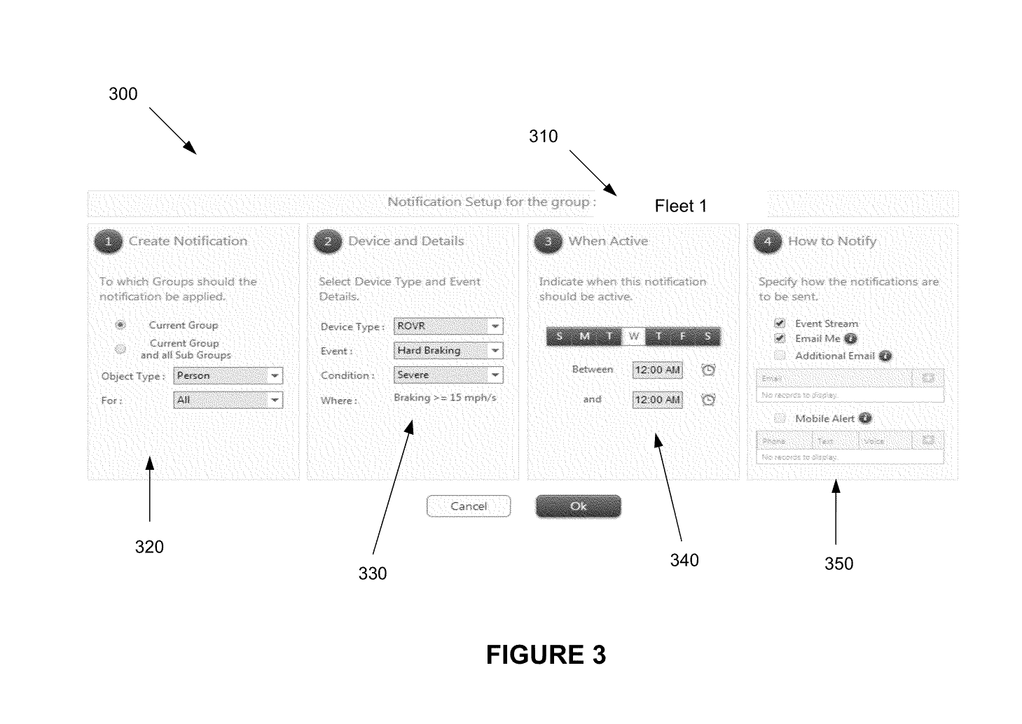

FIG. 3 is an example graphical user interface 300 running on a device capable of transmitting and receiving messages such as a server, a personal computer, a smartphone, a cell phone, a telephone without a GUI, and the like. The device may also comprise devices capable of receiving and transmitting messages, and motion and location information such as GPS, smartphones, personal computers, and the like.

GUI 300 can include a parameter 310 to indicate which device, driver, or group of drivers, the user would like to receive streaming information about. In this example the group of drivers is designated by FLEET 1. Parameter 310 may also be presented as a drop down box with available drivers and/or groups of driver the user may select from. This drop down menu may only include the drivers and groups the user supervisees or has permission to receive information about.

GUI 300 can include parameter 320 in which the user can select who or what is to be monitored. This may include an indication of an object type. Object type may include a device, an asset, a vehicle, or a person, as well as other object types. Parameter 320 can also include an indication of if the notification is for all persons, etc. or for individuals, or particular devices, etc.

This notification may help change the behavior of the driver who may be driving dangerously. The near real-time delivery of the streaming data may also help a supervisor immediately deal with the behavior instead of waiting for a report at the end of the day, week, or month. This also may help change the behavior of the driver.

GUI 300 can include device and details parameter 330. The user may select metrics such as the type of device the monitored driver has in the monitored vehicle. The device type can also include different monitoring devices, such as safety devices, thief hatch indicators, as well as other devices.

The device the information is received from may include an onboard device coupled to a vehicle, a global device, a device capable of satellite communication, a cell phone, a GPS device, other sensors, or other devices. The device may be capable of communicating via cellular, satellite, Wi-Fi, Internet, Bluetooth, near field, wired, or wireless, or any other type of communication to the computing device. Device may include a switch, or other sensors to provide many type of information to the system.

The on board device may include a device receiving power from the OBD port of the vehicle. The device may receive information from the OBD or CAN bus system, but may not. This other device may include Bluetooth capability, an accelerometer, GPS, cellular communication capability, satellite communication capability, flash memory, a processor, and/or a real-time operating system, and/or other sensors and/or capabilities. These other sensors and capabilities may be used to determine if a driving event has occurred and/or the significance of the driving or other event.

It may also include an event type, such as speeding, acceleration, braking, location, engine emissions, vehicle location, tire pressure, if the seat belt is being used, idling, and others. The event type may be based on the device type selected.

In an example, if the device selected is a vehicle monitor (ROVR), the event types may include fast acceleration, hard braking, speeding, geofence indication, departure, arrival, idling, plug-in, low battery, and a safe house alert, as well as other sections or indications. If the device type is for a global safety device (SPOT), the events may include geofence, help, SOS, safe house alert, check in OK, or temporarily delayed, as well as other events.

The user may also select a condition or minor, moderate severe, or create a custom condition. The minor, moderate, and severe setting may include present values, while the custom setting will allow a user to create a custom setting. If the condition is violated or crossed, a notification may be sent.

In this example the device type is a vehicle monitor (ROVR), the vent is hard braking, and the condition is severe. In this example the severe condition setting is braking of >=15 mph/sec. The speed and deceleration may be known from a GPS device adjacent the vehicle, such as in device 100 or other device associated with the vehicle. The parameter may also include the value, such as the actual speeds of the vehicle.

GUI 300 may also include a customizable parameter of when the event streaming is active 340. The user may select when to monitor the driver and vehicle. The monitoring and/or streaming may only take place when the driver is working, or on the clock, such as Monday through Friday from 8 am to 6 pm. Alternatively, if the driver takes a company vehicle home after a work shift, the vehicle may be monitored continuously to protect the company's asset and reduce liability. Other times may be selected as wanted.

GUI 300 may also include a notification parameter 350 of how the user wants the notification or streaming to be delivered. This may include near real-time streaming to a user interface such as GUI 400. It may also be delivered via email, text, automated telephone call, or any other methods or systems capable of communicating this information.

One or more email addresses, or numbers to call or text may be entered. A driver may set up this system such that it informs the driver and the supervisor. This may help alleviate disagreements, or discrepancies in reporting.

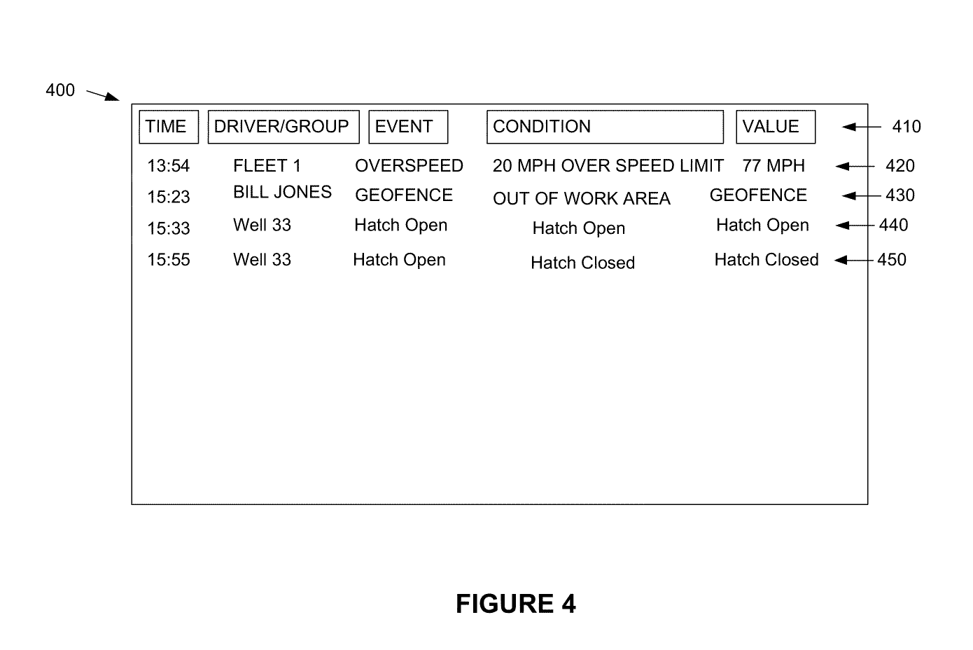

FIG. 4 is an example graphical user interface 400 running on a device capable of transmitting and receiving messages such as a server, a personal computer, a smartphone, a cell phone, a telephone without a GUI, and the like.

GUI 400 may be capable of displaying parameters 410, and metrics/information/data 420, 430. In this example, parameters 410 include time of the event, an identifier of the driver/group, the event, condition and value. It will be appreciated that this list is not exhaustive and other information about the driver or group may be provided to the user. Furthermore, this GUI 400 may be customizable by the user or other person.

In an example, metrics/data 420 may include an indication that at 1:54 pm, someone in FLEET 1 caused an OVERSPEED event to occur. The OVERSPEED event was over 20 MPH over the speed limit, and the actual speed of the monitored vehicle was 77 MPH.

In this example, metrics/data 430 may include an indication that at 3:23 pm, BILL JONES was OUT OF WORK AREA by crossing a Geofence. This may be an indication he was out of the work area during the time when he was supposed to be at the job site. This may be an indication he was running a personal errand, or that he was offsite for a legitimate reason, such as getting material for the job, etc. In this manner the user and the company may better monitor behaviors and assets to reduce risk and liability, among other uses.

In another example, a notification 440 may include information about Well 33 having a hatch open. There may be penalties for leaving hatches open at well sites. This may indicate a hatch is open. Notification 450 may indicate that a short time later the hatch was closed.

It will be appreciated that other information in other formats may be included on the report or notification. This disclosure is not limited in this or any other way or manner.

It should be noted that the disclosure is in no way limited to the discussed implementations. The applicability of the present disclosure extends to many fields including aviation, construction, mining, trucking, and other transportations, teen drivers, remote asset tracking and management, and many other areas. The systems and methods described herein may reduce company liability risk and may provide more information about drivers, assets, and company vehicles. It also may be used to change driving behaviors, thereby reducing risk.

FIGS. 1-4 and the previous descriptions depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for customizable driver information notifications for a company driving safety program, comprising:
presenting one or more parameters generally related to a device and event(s) associated with an asset to a user at least in part via an interface of a computing device;
receiving settings indications for the one or more parameters via the user interface;
implementing the settings indications of the one or more parameters by the computing device;
receiving information from the device; and
providing a notification generally related to the events, based at least in part on the received information, the one or more parameters, or the settings indications.

2. The method of claim 1, wherein the notification is presented on a personal communication device.

3. The method of claim 1 wherein the device comprises an on board device, a cellular telephone, global device, satellite communication device, or a global positioning device.

4. The method of claim 1, wherein the event(s) comprise at least one of help, SOS, safe house alert, check in OK, temporarily delayed, fast acceleration, hard braking, speeding, geofence indication, departure, arrival, idling, plug-in, and low battery.

5. The method of claim 1 wherein the device is associated with an asset.

6. The method of claim 1, wherein the asset comprises a vehicle, hatch, tank, or person.

7. The method of claim 1, wherein the settings indications comprise a device type, event type, and condition.

8. The method of claim 1, wherein setting indications comprise a threshold, and the notification is based at least in part on a condition that crosses the trheshold.

9. The method of claim 1, wherein the settings indications comprise a notification type.

10. The method of claim 1, wherein the notification presented comprises time, device, and event.

11. A system for customizable thresholds for asset information notifications for a asset management program, comprising:
a computing device configured to present one or more parameters generally related to a device and event(s) associated with an asset to a user at least in part via an interface of a computing device; receive settings indications for the one or more parameters via the user interface; implement the settings indications of the one or more parameters;
receive information from the device; and present a notification generally related to the event(s), based at least in part on the received information, the one or more parameters, or the settings indications, wherein the settings indications comprise a device type, event type, and condition.

12. The system of claim 11 wherein the device comprises an on board device, a cellular telephone, global device, satellite communication device, or a global positioning device.

13. The system of claim 11, wherein the event(s) comprise at least one of help, SOS, safe house alert, check in OK, temporarily delayed, fast acceleration, hard braking, speeding, geofence indication, departure, arrival, idling, plug-in, seat belt engaged and low battery.

14. The system of claim 11 wherein the device is associated with an asset.

15. The system of claim 11, wherein the asset comprises a vehicle, hatch, tank, or person.

16. A non-transitory computer readable medium having stored thereon program instructions executable by a computing device that, if executed by the computing device, direct the computing device to:
present one or more parameters generally related to a device and event(s) associated with an asset to a user at least in part via an interface of a computing device;
receive settings indications for the one or more parameters via the user interface;
implement the settings indications of the one or more parameters by the computing device;
receive information from the device; and
provide notifications generally related to the events, based at least in part on the received information, the one or more parameters, or the settings indications,
wherein the device comprises an on board device, a cellular telephone, global device, satellite communication device, or a global positioning device,
wherein the settings indications comprise a device type, event type, and condition.

17. The computer readable medium of claim 16, having further instructions wherein the device is associated with an asset, and the asset comprises a vehicle, hatch, tank, or person.

18. The computer readable medium of claim 16, having further instructions wherein the event(s) comprise at least one of help, SOS, safe house alert, check in OK, temporarily delayed, fast acceleration, hard braking, speeding, geofence indication, departure, arrival, idling, plug-in, and low battery.

19. The computer readable medium of claim 16, having further instructions wherein the presented notification comprises device type and event type.

20. The computer readable medium of claim 16, having further instructions wherein the event type is based at least in part on the device type.
